(19) United States
(12) Patent Application Publication
(10) Pub. No.: US 2008/0282812 A1
(43) Pub. Date: Nov. 20, 2008

(54) Magnetostrictive load sensor and method of manufacture

(76) Inventors: Thaddeus Schroeder, Rochester Hills, MI (US); Bruno Lequesne, Troy, MI (US)

Correspondence Address: DELPHI TECHNOLOGIES, INC., M/C 480-410-202, PO BOX 5052, TROY, MI, 48007, US

(21) Appl. No.: 11/803,550

(22) Filed: May 15, 2007

(51) Int. Cl. G01L 1/04; H02K 15/00

(52) U.S. Cl. 73/862.626; 29/596

(57) ABSTRACT

This invention relates to a load sensor comprising a member composed of electrically conductive magnetostrictive material. The member is a uniform and continuous distribution of wire or strip material abutting itself between opposite ends. The magnetostrictive material is annealed and abutting portions of the member are spaced apart from one another using insulation incorporating microspheres. Terminals at different portions of the member allow the member to be electrically connected in a circuit for measuring an impedance of the member. Stress applied along an axis of the member causes a change in the member's permeability that is measurable as a change in impedance of the sensor. The configuration of the sensor can be described as coil shaped or accordion shaped. The wire or strip material comprising the sensor comprise a variety of shapes. Insulation comprises a high strength adhesive filled with high strength ceramic microspheres. A method is also taught in the present application to fabricate the load sensor of the present invention.

### TECHNICAL FIELD

The present invention relates to an apparatus and method for measuring a mechanical load by means of measuring the amount of stress.

### BACKGROUND

Stress sensing have been utilized to measure an applied force, torque or pressure. One type of load sensor includes a conductive wire that is wrapped around a separate core member of magnetostrictive material. Further, the load sensor includes a ferromagnetic carrier that provides a return path for the magnetic flux outside of the core member. An air gap exists between the ferromagnetic carrier and the core member. An electrical current flowing through the wire coil generates a magnetic field that surrounds the coil and propagates within the core member and the ferromagnetic carrier. A stress applied to the core member changes the magnetic permeability therein. Inductance of the wire coil is a function of the permeability of the material through which the coil's magnetic field flows. Thus, the stress applied to the core member changes the inductance of the wire coil. A drawback with this load sensor is that the air gap offers a permeability several orders of magnitude less than those of the ferromagnetic core or the ferromagnetic carrier, so even a very small air gap significantly increases the magnetic flux reluctance. As a result, the sensitivity of the load sensor is reduced. Further, manufacturing tolerances affect the size of the air gap during manufacture of the load sensors which result in inconsistent load measurements by the sensors.

A load sensor without an air gap is known comprising an electrically conductive member composed of a magnetostrictive material with the load applied directly to the magnetostrictive conductor. A signal generator electrically coupled to the electrically conductive member is included and configured to generate an electrical current that propagates through the electrically conductive member. The apparatus further includes a measuring circuit electrically coupled to the electrically conductive member. The measuring circuit is configured to measure at least one of an amount of inductance, resistance and impedance of the electrically conductive member and is to calculate the amount of force applied to the load sensor based on at least one of the amount of inductance, resistance and impedance of the electrically conductive member.

### SUMMARY OF THE INVENTION

This invention relates to a load sensor comprising a member composed of an electrically conductive magnetostrictive material. The member is a uniform and continuous distribution of wire or strip material abutting itself between opposite ends. The magnetostrictive material is annealed and abutting portions of the member are spaced apart from one another using rigid noncompliant electrical insulation. Terminals at different portions of the member allow the member to be electrically connected in a circuit for measuring an impedance of the member. Stress applied along an axis of the member causes a change in the member's permeability that is measurable as a change in impedance of the sensor. The configuration of the sensor can be described as coil shaped or accordion shaped. The wire or strip material comprising the sensor can have a variety of shapes. Insulation comprises a high strength rigid adhesive, e.g. ceramic cement, fused glass, polymer adhesive filled with high strength ceramic microspheres, or equivalent devices. A method is also taught in the present application to fabricate the load sensor of the present invention.

Many variations in the embodiments of the present invention are contemplated as described herein in more detail. Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views.

FIG. 1 teaches a known device for a coilless sensor;

FIG. 2 teaches a coil-spring shaped load sensor according to the present invention;

FIGS. 3A, B and C teach an accordion shaped load sensor with an open perimeter;

FIG. 3A teaches a preformed strip after annealing;

FIG. 3B teaches a top view;

FIG. 3C teaches a formed strip with rigid insulation between folds;

FIG. 4 teaches a coil-spring shaped load sensor with inner support;

FIG. 5 teaches a coil-spring shaped load sensor with center tap electrical contacts placed symmetrically for use with electrical noise cancellation means;

FIGS. 6A and 6B (a detail of FIG. 7A) shows a sensor layout and direction of stress and magnetic flux;

FIG. 7 teaches a construction with conductors having a height larger than its width (40 to 70% nickel); and

FIG. 8 teaches a construction with conductors having a width larger than its height (85 to 95% nickel).

FIG. 9 teaches a schematic feature of the present invention.

### DETAILED DESCRIPTION OF THE INVENTION

The present invention relates to a magnetostrictive load sensor and a continuous method of manufacturing it.

Magnetostrictive materials have a permeability that varies with stress (Villari effect). Usually, stress is sensed by measuring the inductance of a coil (usually of a copper wire) wound around a core made of a magnetostrictive material such as nickel-iron alloy. These conventional sensors have at least two parts, a coil and a core. U.S. patent application Ser. No. 11/244,792, filed Oct. 6, 2005 entitled “Apparatus, Sensor and Method for Measuring an Amount of Strain and U.S. patent application Ser. No. 11/713,961, filed Mar. 5, 2007 entitled “Apparatus, System and Method assuring Stress”, show use of a magnetostrictive core as both conductor and magnetic core, whereby a sensor has only one component. This is referred to as a “coilless” sensor design. Aside from part reduction, the coilless concept eliminates magnetic airgaps, which are a source of sensor performance variability.

U.S. patent application Ser. No. 11/713,961 describes a ring-shaped load sensor, for example to sense force in an automotive electric brake caliper.

An impediment surfaced about heat treatment and electrical insulation for known sensors. These sensors as with most magnetic materials exhibit better and more consistent behavior after they have been annealed, which involves high temperatures. At the same time, the sensor ring must be electrically insulated with a rigid insulator, both from the outside, and, if the sensor comprises several rings, each ring must be insulated from its neighbor. Applying insulation prior to annealing, although possible, severely limits the choice of suitable insulating compounds and methods of application. Insulation containing organic components could not survive the high temperature of annealing. What is needed is a sensor design permitting a post-annealing application of insulation without reducing the benefits of annealing. In addition needed is a suitable rigid electrical insulation and method of application.

The present invention addresses those deficiencies in the prior art. In particular, the sensor shape and the manufacturing steps include a design that lends itself to a simple manufacturing process and that makes for easy application of insulation material on the sensor, after it has been annealed.

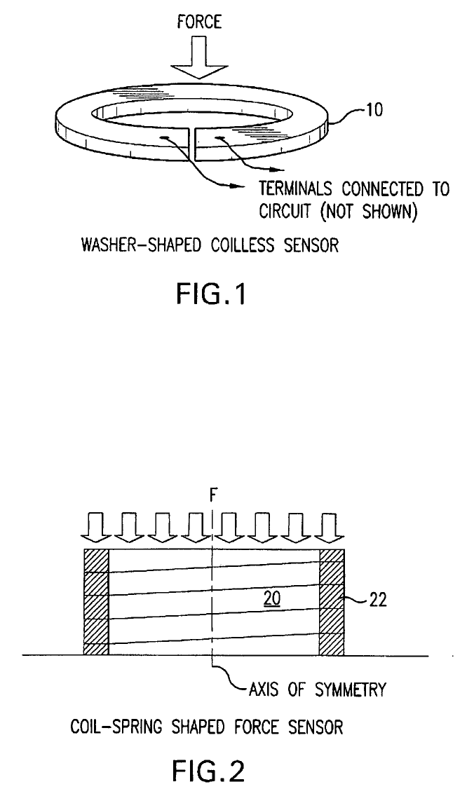

In U.S. patent application Ser. No. 11/713,961, a coilless sensor design is shown which is shaped like a washer 10. See FIG. 1.

With a single washer, however, inductance is low and it is desirable to have several such washers in series. If several washers are used, however, they must be insulated from one another.

This insulation unfortunately will not survive the high-temperature heat treatment (annealing) that is necessary to obtain desirable, consistent magnetic behavior. Annealing is a process that involves exposure to high temperature. See for instance the annealing condition for “Alloy 49” manufactured by Carpenter Technology Corporation, which is an alloy of nickel and iron (about 50-50). Such alloys (about 50-50 nickel and iron) are good candidates for the involved application.

According to the Carpenter Technology Corporation website standard hydrogen anneal is described as:
For maximum softness and optimum magnetic and electrical properties, Carpenter High Permeability “49” alloy should be annealed in an oxygen-free, dry hydrogen atmosphere with a dew point below −40° F. (−40° C.) for 2 to 4 hours at 2150° F. (1177° C.), followed by a furnace cool at a rate of 100/200° F. (38/93° C.) per hour down to 800° F. (427° C.) and at any rate thereafter.
Oil, grease, lacquer and any other contaminants must be removed before annealing. During hydrogen annealing, the individual parts should be separated by a surface insulation media or an inert insulating powder, such as magnesium or aluminum oxide.

### Sensor Design

The design of the sensor according to the present invention is like an accordion-shaped strip. Exemplary embodiments of an “accordion-shaped strip” are presented.

In one embodiment, the strip is shaped like a coil spring, where the coils are shaped like flat washers. See FIG. 2. Although the sensor has the general shape of a spring 20, its coils 22 are meant to be, including their rigid electrical insulation, in a mechanical contact with one another even when at rest (no compression needed for this contact). These contacts while at rest make for a solid force path F to generate the desired signal. In that sense, rather than a spring, a better analogy may be a popular toy known as the SLINKY®.

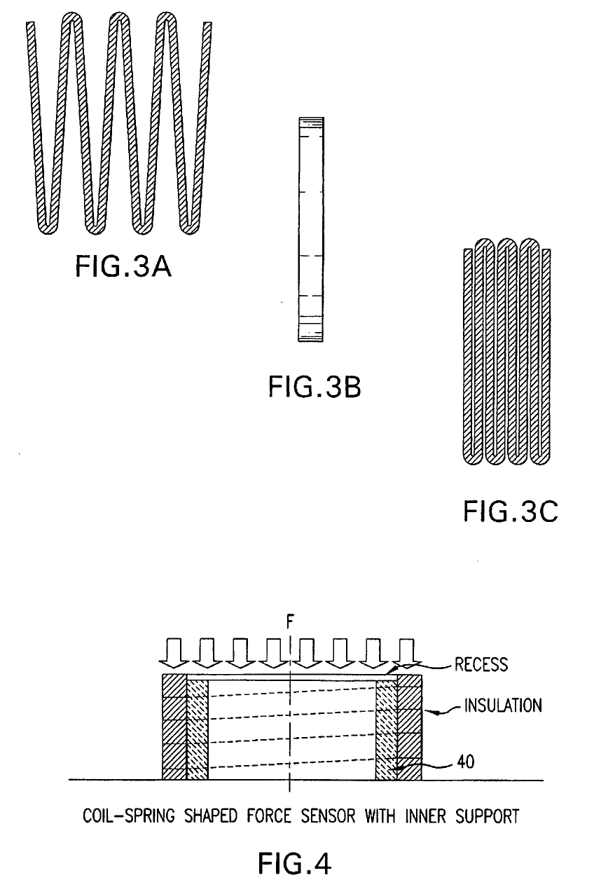

In another embodiment, the strip is rectangular in shape. In this embodiment, the sensor has an open perimeter in contrast to the above described coil spring configuration having a closed perimeter. In the simplest case, it would be a sensor sensing a load along a short line segment (straight or curved). Now, instead of forming the strip into a coil spring shape, the strip is formed into a shape as shown in FIG. 3.

Other shapes, with a closed or with an open perimeter, can be envisioned.

The FIG. 2 and FIG. 3 configurations have the following features:

Long continuous conductor: The several turns encompassing the sensor make for as long a conductor as possible within the available package. A long conductor has a larger inductance, therefore providing a larger voltage for a given current (inductance is proportional to length).

Sturdy assembly: The assembly will be subjected to force repeatedly. For this design, sturdiness is further enhanced by setting the sensor next to or within a supporting member or members. For a coil-spring shape, the supporting member is desirably a cylinder. An inner supporting cylinder 40 is shown in FIG. 4. An outer cylinder (now shown) is also possible (or both inner and outer cylinders). The supporting block may be slightly recessed, as shown, so that the force F is applied exclusively on the sensing element.

Easy manufacturing: Known and inexpensive manufacturing techniques are available for strips and coil springs. Such structures are made in long segments and then cut to desired length.

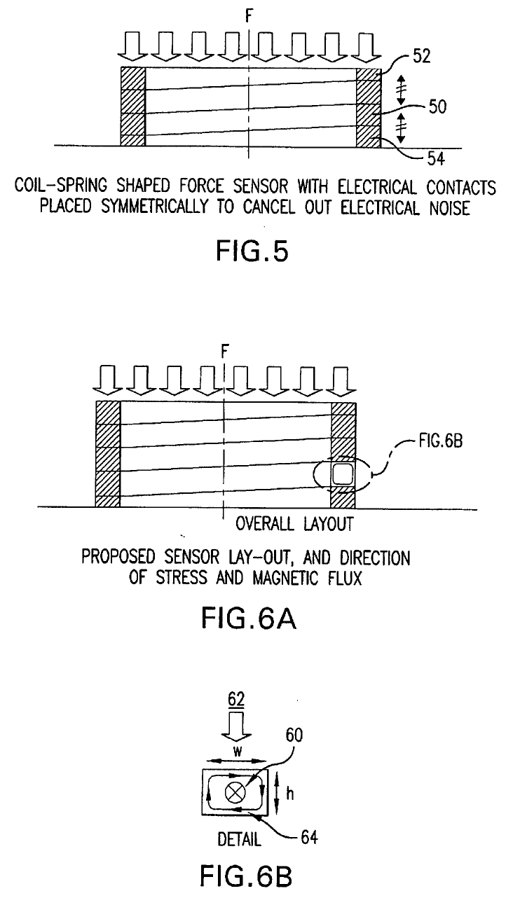

Convenient electrical contacts: Electrical contacts can be located in various places depending on intended use. In a convenient design, the contacts are disposed on the top and bottom of the sensor. For some uses, current flow in opposite directions is desirable to cancel out potential electric noise. This can be achieved with a center tap contact 50 (FIG. 5). Symmetry can be achieved with both top 52 and bottom 54 of the sensor having the same shape, length, exposure to force (hence same inductance both at no-load and under load), as well as symmetrical exposure to noise.

Application of insulation: The strip or spring shape makes it easy to stretch and separate the individual coils from one another, easy to have uniform spacing of the coils during application of the insulation (thus uniform insulation). This separation of the coils is sufficient to apply insulating material, and at the same time makes it easy to bring the overall assembly back into its solid final shape. This key feature is further detailed below.

Sensor Design—Embodiments Depending on Sensor Material

The disclosure presented above express characteristics of the invention. The design also adapts to the type of magnetostriction of the material used to fabricate the sensor. This is due to the magnetostrictive effect being strong when the magnetic flux lines are aligned with, or normal with, the stress, depending on whether it is a compressive or a tensile stress, and depending on sensor material.

Depending on sensor material, magnetostriction has either a positive or negative coefficient. The coefficient of magnetostriction which exhibits a positive or negative sign is the ratio of change of permeability for a given change in stress applied, or coefficient λ—R. M. Bozorth, Ferromagnetism, IEEE Press, Wiley-Interscience, John Wiley and Sons, Inc., Hoboken, N.J., 3rd edition (2003):

λ=Δμ/Δσ

where μ and σ are the material permeability and applied stress, respectively.

Materials with a negative coefficient of magnetostriction when used in compression must have the flux lines generally aligned with the stress, as summarized in Table I. For materials with a positive coefficient of magnetostriction, when in compression, the magnetic flux lines are desirably normal to the stress lines. See Table II. Tables I and II also show the case of tensile stress, for completeness.

TABLE I
Conditions for materials with a negative magnetostriction coefficient

| Materials with a negative | Stress in line | |
|---|---|---|
| magnetostriction coefficient | with flux | Stress normal to flux |
| Tensile stress | Very small change | Large change in |
| | in permeability | permeability |
| Compression stress | Large change in | Very small change in |
| | permeability | permeability |

TABLE II
Conditions for materials with a positive magnetostriction coefficient

| Materials with a positive | Stress in line | |
|---|---|---|
| magnetostriction coefficient | with flux | Stress normal to flux |
| Tensile stress | Large change in | Very small change in |
| | permeability | permeability |
| Compression stress | Very small change | Large change in |
| | in permeability | permeability |

A desirable type of material is a nickel-iron alloy, because it exhibits a large coefficient λ, and is relatively strong and inexpensive. Nickel-iron alloys, however, can exhibit either a positive or negative coefficient of magnetostriction, depending on the nickel content of the alloy. R. M. Bozorth, p. 616.

For force sensors where the stress is compressive, and for nickel-iron alloys with nickel content between 40% and 70%, the magnetic flux lines must be in line with the stress lines. For nickel-iron alloys with nickel content between 85% and 95%, the flux lines must be normal to the stress. Looking at the proposed design, the flux lines and stress directions are as shown in FIG. 6.

Referring to FIG. 6, a compressive stress F is applied vertically onto the sensor. The current 60 is normal to the plane of the figure and normal to the stress 62. The magnetic flux 64 surrounds the current according to Ampère's law. If the conductor is essentially rectangular with a width w and a height h, then the magnetic flux is aligned with the stress over the height h and normal to the stress over the width.

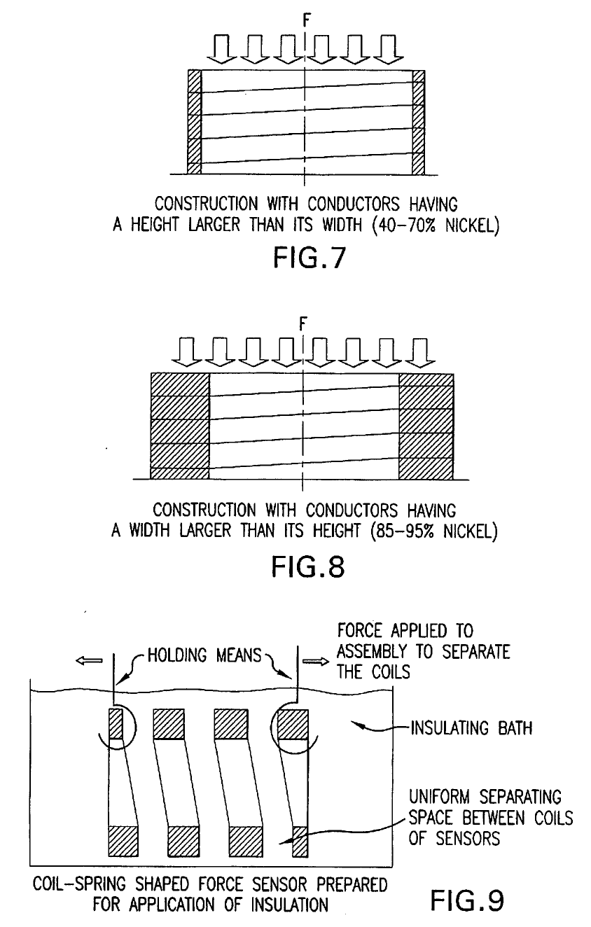

It follows that, if the material has a negative coefficient of magnetostriction (e.g., nickel-iron with 40-70% nickel content); the cross-section of the conductor is such that its height is larger than its width. Conversely, if the material has a positive coefficient of magnetostriction (e.g., nickel-iron with 85-95% nickel content), the cross-section of the conductor is such that its width is larger than its height. These two cases are shown in FIGS. 7 and 8, respectively.

An inspection of FIGS. 7 and 8 shows that a construction with a larger width (FIG. 8) is more desirable. It shows a more sturdy construction. More turns can be fitted within a given space, and more turns means more inductance. The height of each turn can be very small for the embodiment of FIG. 8, whereas the width cannot be very small for the embodiment of FIG. 7, for overall solidity reasons.

Unfortunately, the magnetostriction coefficient is not as strong for nickel-iron with nickel content around 90% as with a nickel-iron with nickel content between 40-70%. Also, the alloys which are predominantly nickel are not as strong mechanically (lower stress limit); alloys with 49 to 50% nickel are more commonly available. Designs (FIG. 7 and FIG. 8) depends on intended use.

Sensor design can follow patterns:

One pattern: Material being a nickel-iron with 85-95% nickel content, and width being larger than height. Height is very small (thin layers), and a sensor being made of many turns within a given space.

Another pattern: Material being a nickel-iron with 40-70% nickel content, and height being larger than width.

Manufacturing Steps and Application of Insulation Material

Step 1: The sensor is manufactured as a long flat strip. Step 2: Next it will be formed into a coil with the desired perimeter shape—e.g. closed or open (circular of non-circular). Step 3: It will then be annealed. Step 4: Then, insulation applied. Two additional steps, cutting the coil to length, and feathering the top and bottom ends of the strip to provide flat parallel surfaces for contact, are optional. These latter two steps can be performed before annealing, after annealing, or at the end of the process. Logically, this occurs before insulation is applied because the insulation most likely will need to cover all of the sensor surfaces, unless the sensor is placed within non-conducting material.

By its very shape, the sensor coils can be separated from one another by simply pulling on extremities. This is possible without permanent deformation, and without applying a level of excessive stress to the sensor coils that could undo at least in part the annealing benefits. This is shown schematically in FIG. 9. Once the coils are separated, insulation can be applied by any one of the following procedures, as well as other known methods:

1) Bathing the device in an appropriate liquid (FIG. 9);

2) Spraying the sensor surfaces; or

3) Combining with prefabricated insulation strip.

Insulation

An example of insulation is a high-strength adhesive (e.g. epoxy or other polymers) filled with high-strength ceramic or glass microspheres, whereby the largest diameter spheres will establish the spacing between the coils or folds of the sensor. The volume concentration of microspheres in the adhesive must be sufficient for providing a uniform transfer of stress between adjacent coils or folds. However, the microspheres should not be so large as to affect the viscosity or thixotropy, which would adversely impact the adhesive application process. The idea is to choose microspheres possessing specific properties and size distribution.

First, to insure adhesive compatibility and prevent compromise of adhesive properties, the microspheres must have an appropriate surface chemistry and resultant adhesion to the cured adhesive. The microspheres must also have a minimum isostatic compressive strength and/or yield stress to insure enough load bearing capability.

Secondly, to create and maintain a specified gap thickness, the microsphere size distribution must contain a sufficient number of spheres of a specific maximum diameter. Typically, this diameter would fall somewhere in the range of 50 to 100 microns, but it would, for any assembly, be a specific value, say 75 microns. To meet this requirement, commercially available size distributions, which are typically described by a normal probability distribution, must be fractionated in such a way that all particles with a diameter greater than the desired maximum be removed. This can be accomplished, for example, by sonically and mechanically sifting through meshes of appropriate sizes. The required number of maximum diameter microspheres per unit area of bonded surface and the bond thickness will determine the number of microspheres per unit volume of the fractionated size distribution which must be premixed into the adhesive.

Microspheres are inexpensive and widely used. There are many suppliers. High-strength solid ceramic microspheres made by 3M Company, under the name Zeeospheres Ceramic Microspheres, are suitable. These are silica-alumina or alkali aluminum silicate ceramic. See U.S. Patent Application Publication 2006/0118989.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims. References noted above are hereby incorporated by reference.

1. A load sensor comprising:
a member composed of electrically conductive magnetostrictive material, the member being a uniform and continuous distribution of annealed wire or strip material abutting itself between opposite ends, and abutting portions of the member being spaced apart from one another using rigid electrical insulation; terminals at different portions of the member allowing the member to be electrically connected in a circuit for measuring an impedance of the member; wherein a stress applied along an axis of the member causes a change in the permeability of the member that is measurable as a change in impedance of the sensor.

2. The load sensor according to claim 1, wherein the wire or strip material being nickel-iron alloy.

3. The load sensor according to claim 1, wherein the shape of the member is an accordion-shape.

4. The load sensor according to claim 3, wherein the member having a shape of a coil spring.

5. The load sensor according to claim 4, wherein the member having a closed perimeter.

6. The load sensor according to claim 3, wherein the member having a shape of a rectangular strip.

7. The load sensor according to claim 6, wherein the member having an open perimeter.

8. The load sensor according to claim 1, wherein the sensor further comprising a supporting member.

9. The load sensor according to claim 8, wherein the supporting member being cylindrical.

10. The load sensor according to claim 9, wherein the supporting member being interior of the sensor.

11. The load sensor according to claim 9, wherein the supporting member being exterior to the sensor.

12. The load sensor according to claim 1, wherein the insulation being a polymer.

13. The load sensor according to claim 12, wherein the insulation is filled with electrically nonconductive microspheres.

14. A method for making a load sensor comprising:
making a length of electrically conductive magnetostrictive material, forming length into an accordion shape with a desired perimeter shape; annealing the accordion shaped length; applying insulating material to the accordion shaped length whereby the insulating material displaces abutting magnetostrictive material.

15. The method for making the load sensor according to claim 14, wherein the insulating material is polymer.

16. The method for making the strain sensor according to claim 15, wherein the insulating material being filled with electrically nonconductive microspheres.

17. The method for making the load sensor according to claim 14, further comprising cutting the accordion shaped member to a desired length and feathering top and bottom ends of the accordion shaped member to provide substantially flat parallel surfaces for contact.

18. The method for making the load sensor according to claim 16, wherein the diameter of the electrically nonconductive microspheres is about 50 to 100 microns.
